(19) United States
(12) Patent Application Publication
(10) Pub. No.: US 2011/0304950 A1
(43) Pub. Date: Dec. 15, 2011

(54) ELECTRIC DOUBLE LAYER CAPACITOR

(75) Inventors: Keisuke Ohtsuka, Shiga (JP); Kenzou Takahashi, Osaka (JP); Mai Koyama, Osaka (JP)

(73) Assignee: DAIKIN INDUSTRIES, LTD., Osaka-shi, Osaka (JP)

(21) Appl. No.: 13/202,873

(22) PCT Filed: Feb. 25, 2010
(86) PCT No.: PCT/JP2010/001293

§ 371 Date: Aug. 23, 2011

(30) Foreign Application Priority Data
Feb. 25, 2009 (JP) 2009-042925

(51) Int. Cl. H01G 9/058

(52) U.S. Cl. 361/502

(57) ABSTRACT

An electric double layer capacitor includes a pair of collectors, a separator, a conductive coating film, a polarizable electrode, and an electrolyte solution. The separator is arranged between the collectors. The conductive coating film covers a surface of at least one of the collectors facing the separator. The polarizable electrode is formed as to be in contact with at least a surface of the conductive coating film facing the separator. Preferably, electrolyte solution has a fluorine-containing organic solvent, and is impregnated into the polarizable electrode. Preferably, the capacitor enables an operating voltage of 3.5 V or higher.

### TECHNICAL FIELD

The present invention relates to an electric double layer capacitor.

### BACKGROUND ART

In recent years, an electrolyte solution to which high voltage can be applied (hereinafter referred to as “high voltage electrolyte solution”) has been developed with the aim to improve the energy density of an electric double layer capacitor (see, e.g., Patent Literature 1 (Japanese Published Unexamined Patent Application Publication No. 2008-016560)).

However, when the present inventors evaluated the performance of an electric double layer capacitor by replacing the conventional electrolyte solution with a high voltage electrolyte solution, it has become clear that an electric discharge matching the charging voltage cannot be sufficiently obtained due to a large voltage decrease during discharge. The present inventors have diligently investigated this phenomenon, and found that the cause of this is that the electric resistance at the interface between the polarizable electrode, which is activated carbon, and the collector, which is aluminum thin plate, increases significantly when high voltage is applied to the electric double layer capacitor for charging. The present inventors further came to believe that this significant increase in electric resistance may be caused by a porous film reversibly formed from the conversion of a natural oxide film at the surface of an aluminum thin plate when applying high voltage (see, e.g., Non-patent Literature 1 (Izaya Nagata, “Aluminum Electrolyte Capacitor with Liquid Electrolyte Cathode,” Japan Capacitor Industrial CO., LTD, Feb. 24, 1997)).

Meanwhile, one method thought to solve such problem is, for example, a method to chemically stabilize the surface of an aluminum thin film. A method of “heat-treating the collector aluminum thin film to form a stable oxide film on the aluminum thin film” has been previously proposed as a method for such stabilization of the surface of an aluminum thin film (see, e.g., Patent Literature 2 (Japanese Published Unexamined Patent Application Publication No. 2000-156328)). However, since aluminum oxide is an insulating substance, the above problem cannot be expected to be solved by such a method.

### SUMMARY OF THE INVENTION

### Technical Problem

The object of the present invention is to reduce the voltage decrease during discharge in order to obtain an electric discharge which is as close as possible to the electric discharge matching the charging voltage, in an electric double layer capacitor wherein an electrolyte solution to which high voltage can be applied is sealed in.

### Solution to Problem

The electric double layer capacitor according to the first aspect of the present invention comprises a pair of collectors, a separator, a conductive coating film, a polarizable electrode, and an electrolyte solution. The separator is arranged between the collectors. The conductive coating film covers a surface facing the separator among the surfaces of at least one of the collectors. The polarizable electrode is so formed as to be in contact with at least a surface of the conductive coating film facing the separator among the surfaces of the collector and the conductive coating film. The “polarizable electrode” as used herein is for example activated carbon. The electrolyte solution comprises a fluorine-containing organic solvent as the solvent, and the solution is impregnated into the polarizable electrode. The “fluorine-containing organic solvent” as used herein is for example fluorine-containing ethers and fluorine-containing lactones.

As a result of diligent investigations of the present inventors, by coating the collector with the conductive coating film, and forming the polarizable electrode on the conductive coating film as described above, it has become clear that an electric discharge close to the electric discharge matching the charging voltage is obtained due to a smaller voltage decrease during discharge than that without a conductive coating film when applying high voltage. For this reason, this electric double layer capacitor can discharge electricity with a discharge close to the electric discharge matching the charging voltage due to a smaller voltage decrease during discharge than that without a conductive coating film when applying high voltage.

Because in the present invention the solvent of the electrolyte solution is a fluorine-containing organic solvent, it is superior in flame resistance and low-temperature property.

The electric double layer capacitor according to the second aspect of the present invention is an electric double layer capacitor which enables an operating voltage of 3.5 V or higher, which comprises a pair of collectors, a separator, a conductive coating film, a polarizable electrode, and an electrolyte solution. The separator is arranged between the collectors. The conductive coating film covers a surface facing the separator among the surfaces of at least one of the collectors. The polarizable electrode is so formed as to be in contact with at least a surface of the conductive coating film facing the separator among the surfaces of the collectors and the conductive coating film. The “polarizable electrode” as used herein is for example activated carbon.

Moreover, “enables an operating voltage of 3.5 V or higher” as used herein means that the capacitance and internal resistance after endurance test under the following test standards fulfill (1) and (2) below:

(1) in a measurement standard compliant with RC-2377, which is a test method for an electric double layer capacitor, the capacitance is 70% or more of the initial value; and
(2) in a measurement standard compliant with RC-2377, which is a test method for an electric double layer capacitor, the internal resistance is 4 folds or less of the initial value.

As a result of diligent investigations of the present inventors, by coating the collector with the conductive coating film, and forming the polarizable electrode on the conductive coating film as described above, it has become clear that an electric discharge close to the electric discharge matching the charging voltage is obtained due to a smaller voltage decrease during discharge than that without a conductive coating film when applying high voltage. For this reason, this electric double layer capacitor can discharge electricity with a discharge close to the electric discharge matching the charging voltage due to a smaller voltage decrease during discharge than that without a conductive coating film when applying high voltage.

The electric double layer capacitor according to the third aspect of the present invention is the electric double layer capacitor according to the first or second aspect, wherein the electrolyte solution has a reaction current 0.1 mA/F or less in a stable state when a voltage of 3.3 V is applied thereto at 70° C.

The electric double layer capacitor according to the fourth aspect of the present invention is the electric double layer capacitor according to any of the first to third aspects, wherein the conductive coating film is formed of graphite. It is preferred that the graphite as used herein has a graphitization degree of 0.6 or more to 0.8 or less. An example of such a conductive coating film can be formed from Varniphite (registered trademark) from Nippon Graphite Industries, ltd.

On that account, a conductive coating film can easily and inexpensively be formed for this electric double layer capacitor.

The electric double layer capacitor according to the fifth aspect of the present invention is the electric double layer capacitor according to any of the first to fourth aspects,

wherein the collector is aluminum.

On that account, this electric double layer capacitor can have good corrosion resistance.

### Advantageous Effects of Invention

The electric double layer capacitor according to the first aspect of the present invention is superior in flame resistance and low-temperature property, the voltage decrease during discharge is smaller than that without a conductive coating film when applying high voltage, and can carry out an electric discharge close to the electric discharge matching the charging voltage.

The electric double layer capacitor according to the second and third aspects of the present invention can discharge electricity with a discharge close to the electric discharge matching the charging voltage due to a smaller voltage decrease during discharge than that without a conductive coating film when applying high voltage.

A conductive coating film can easily and inexpensively be formed for the electric double layer capacitor according to the fourth aspect of the present invention.

The electric double layer capacitor according to the fifth aspect of the present invention can have good corrosion resistance.

### BRIEF DESCRIPTION OF THE DRAWINGS

FIG. 1 is a simplified configuration diagram of the electric double layer capacitor according to the embodiments of the present invention.

FIG. 2 is a graph representation corresponding to Table 1.

FIG. 3 is a graph representation corresponding to Table 2.

FIG. 4 is a cross-sectional SEM photograph of a state where the conductive coating film is formed in Example 1.

FIG. 5 is a cross-sectional SEM photograph of a state where the conductive coating film is not formed in Comparative Example 1.

### DESCRIPTION OF EMBODIMENTS

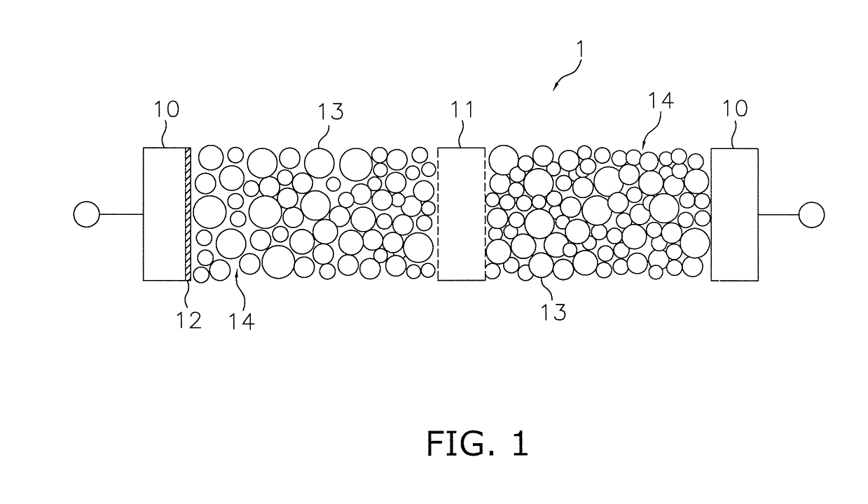

As shown in FIG. 1, an electric double layer capacitor 1 according to the present invention primarily comprises a container (not shown), a pair of collectors 10, a separator 11, a conductive coating film 12, a polarizable electrode 13, and an electrolyte solution 14.

### (Collector 10)

The collector 10 is for example a thin plate consisting of a conductive substance such as aluminum.

The collector 10 may be any collector having chemical or electrochemical corrosion resistance. For the collector of polarizable electrode having activated carbon as the main constituent, aluminum as well as e.g. stainless steel, titanium, or tantalum can be preferably used. Among these, stainless steel or aluminum are particularly preferred materials in regards to both the properties of the electric double layer capacitor 1 obtained and price. In addition, aluminum is more preferable due to its superiority in corrosion resistance.

The purity of the metal in collector 10 is preferably 99.8% or higher.

Moreover, the surface treatment of collector 10 may be roughening such as by sandblasting, chemical etching, and electrolytic etching, or those having a smooth surface.

### (Conductive Coating Film 12)

In addition, the surface of one of the collectors 10 facing the separator 11 is covered with a conductive coating film 12. This conductive coating film may also cover the surface of the other collector facing the separator 11. It is also preferred that this conductive coating film 12 is formed for example from graphite, and its graphitization degree is 0.6 or more to 0.8 or less.

When the thickness of the polarizable electrode 13 is set at about 100 μm as an electric double layer capacitor for high power application, the thickness of the conductive coating film 12 is preferably in the range of 10 μm-30 μm. If the thickness of the conductive coating film is less than 10 μm, there is a risk that the suppression effect against porous film formation may not be sufficient; if the thickness of the conductive coating film is greater than 30 μm, there is a concern that energy density decreases and internal resistance will also rise.

Further, when the thickness of the polarizable electrode 13 is set at about 300 μm-500 μM as an electric double layer capacitor for high capacity application, the thickness of the conductive coating film 12 is preferably in the range of 60 μm-100 μm considering the balance between the suppression effect against porous film formation and decrease in capacitance density.

### (Separator 11)

The separator 11 is a thin plate consisting of a non-conductive substance such as paper or fiber nonwoven fabric. This separator 11 is arranged between the pair of collectors 10.

### (Polarizable Electrode 13)

The polarizable electrode 13 is formed of for example activated carbon, and arranged between the collector 10 and the separator 11. Note that this polarizable electrode 13 is actually formed on the collector 10 or the conductive coating film 12 as a coated film.

Examples of activated carbon used for the polarizable electrode 13 include phenol resin-based activated carbon, coconut shell-based activated carbon, and petroleum coke-based activated carbon. Among these, the use of petroleum coke-based or phenol resin-based activated carbon is preferred in that large capacity is obtained. Further, examples of activation methods for activated carbon include steam activation and molten KOH activation, with the use of activated carbon by molten KOH activation being preferred due to a larger capacity obtained.

As the activated carbon employed for the polarizable electrode 13, it is also preferred to use activated carbon having an average grain size of 20 μm or less and a specific surface area of 1500-3000 m²/g in order to obtain an electric double layer capacitor having large capacity and low internal resistance.

Carbonaceous materials such as carbon black, graphite, expanded graphite, porous carbon, carbon nanotube, carbon nanohorn, and Ketjen Black may also be employed in place of or in combination with the activated carbon described above for the polarizable electrode 13.

The density of the polarizable electrode 13 is preferably 0.37-0.40 g/cm³ (low density).

Moreover, the coating for forming the conductive coating film 12 may be applied and dried, and then the coating for forming the polarizable electrode 13 may be applied and dried, or a part of the surface of the conductive coating film 12 may be melted while forming the polarizable electrode 13 when applying the coating for forming the polarizable electrode 13 for a continuous structure having no interface between the conductive coating film 12 and the polarizable electrode 13. In other words, the conductive coating film 12 and the polarizable electrode 13 may be distinctly separated into two layers, or the polarizable electrode 13 may be impregnated into the conductive coating film 12 to create a state where the polarizable electrode 13 is dispersed inside the conductive coating film 12, as long as it has a portion where the conductive coating film 12 exists at least between the polarized film 13 and the collector 10.

### (Electrolyte Solution 14)

The electrolyte solution 14 is preferably one where the solvent is a fluorine-containing organic solvent, or one where chemical degradation does not occur even when an operating voltage of 3.5 V or higher is applied. For example, such an electrolyte solution 14 is desirably an electrolyte solution which has a reaction current 0.1 mA/F or less in a stable state when a voltage of 3.3 V is applied thereto at 70° C.

For the electrolyte solution 14 for the electric double layer capacitor 1, it is preferred to use a fluorine-containing organic solvent instead of carbonates or lactones as the solvent for dissolving the electrolytic salt in the following regards. That is, chemical degradation does not occur easily even when a voltage of 3 V or higher is applied. In addition, the risk of firing upon overcharging/overheating can be avoided due to low flash point and high flammability. Moreover, viscosity does not easily increase, and decrease in conductivity can be reduced even at a low temperature to suppress reduction in output (low-temperature property). Hydrolyzability can be reduced to facilitate use. It is particularly preferable that such electrolyte solution 14 is a non-aqueous electrolyte solution that has high solubility of electrolytic salt, is stable even under basic conditions, and also has superior compatibility with hydrocarbon solvents. Such a fluorine-containing organic solvent is preferably a fluorine-containing lactone comprising the electrolyte solution shown by the following Formula (I):

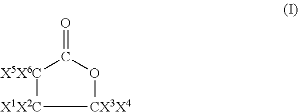

(wherein X¹-X⁶ is identical or different, and all are H, F, Cl, CH₃, or a fluorine-containing methyl group; provided that at least one of X¹-X⁶ is a fluorine-containing methyl group).

The fluorine-containing methyl group in X¹-X⁶ is —CH₂F, —CHF₂, or —CF₃, preferably —CF₃ in regards to good voltage resistance. The fluorine-containing methyl group may substitute all or only one of X¹-X⁶, preferably 1-3, in particular 1-2, in regards to good solubility of electrolytic salt. The position for substituting the fluorine-containing methyl group is not particularly limited, but X³ and/or X⁴, particularly X⁴ is preferably a fluorine-containing methyl group, in particular —CF₃, due to good synthesis yield. X¹-X⁶ other than the fluorine-containing methyl group is H, F, Cl, or CH₃, and in particular H is preferable due to good solubility of electrolytic salt.

In the above fluorine-containing lactone, it is preferred that the atom other than the fluorine-containing methyl group attached to the carbon atom constituting the lactone ring is F and/or H. Moreover, the electrolytic salt is preferably an ammonium salt, particularly preferably a tetraalkyl quaternary ammonium salt, a spirobipyridinium salt, or an imidazolium salt.

The fluorine content of the above fluorine-containing lactone is 10% by weight or more, preferably 20% by weight or more, and particularly 30% by weight or more, and the upper limit is ordinarily 76% by weight, and preferably 55% by weight. The measuring of the fluorine content of the entire fluorine-containing lactone can be measured by ordinary means such as combustion method.

Because fluorine-containing lactone is contained, the solution does not easily separate into two layers and retains its uniformity even when fluorine-containing ether is added for improving flame resistance.

The electrolyte solution 14 as above is described in detail in Japanese Published Unexamined Patent Application Publication No. 2008-016560.

The present invention will now be described in more detail below based on Examples.

### Example 1

### Preparation of Laminated Cell

First, etched aluminum from Japan Capacitor Industrial CO., LTD (product No.: 20CB) was prepared as the collector. The thickness of this etched aluminum was about 20 μm.

Next, a simplified coating device was used to apply 20 μm of Varniphite™ from Nippon Graphite Industries, ltd. (product No.: T602) onto the collector, and then the coated film was dried at 100° C. for 20 minutes to form a conductive coating film on the collector. The thickness of this conductive coating film was 20 μm. Subsequently, 100 parts by weight of activated carbon from Nippon Oil Corporation (product No.: CEP21, surface area: 2100 m²/g), 300 parts by weight of Denka Black (conductive assistant) from Denki Kagaku Kogyo Kabushiki Kaisha, 200 parts by weight of Ketjen Black from Lion Corporation, 400 parts by weight of binder from Zeon Corporation (product No.: AZ-9001), 200 parts by weight of surfactant from Toagosei Co., Ltd. (product No.: A10H) were mixed to prepare a conductive coating. This conductive coating was then applied onto the conductive coating film, and the coated film was dried at 70° C. and 110° C. for 1 hour each in a drying oven to form a polarizable electrode. The thickness of this polarizable electrode was 80 μm.

The collector, the conductive coating film, and the polarizable electrode will collectively be referred to as the thin plate electrode below.

Next, this thin plate electrode was cut into 20×72 mm sizes, an electrode lead-out wire was welded to the etched aluminum, then Celgard No. 2400 from Celgard, LLC. (polyethylene porous film separator, film thickness: 25 μm, density: 0.56 g/cm³, maximum pore size: 0.125×0.05 μm) was placed in between the thin plate electrodes, and housed in a laminated container from Dai Nippon Printing Co., Ltd. (product No.: D-EL40H). The electrolyte solution was injected into the laminated container in a dry chamber, and the laminated container was sealed to complete the laminated cell. The electrolyte solution used was 100 parts by weight of SBP—PF₆ (electrolytic salt) from Japan Carlit Co., Ltd. dissolved in 100 parts by weight of a mixed solvent of 4-trifluoromethyl-1,3-dioxolan-2-one and 1,1,2,2-tetrafluoroethyl-2,2,3,3-tetrafluoropropylether (HCF₂CF₂CH₂OCF₂CF₂H). This electrolyte solution had a reaction current 0.1 mA/F or less in a stable state when a voltage of 3.3 V was applied thereto at 70° C.

Four laminated cells were prepared as above in this Example.

### <Evaluation by SEM Photography>

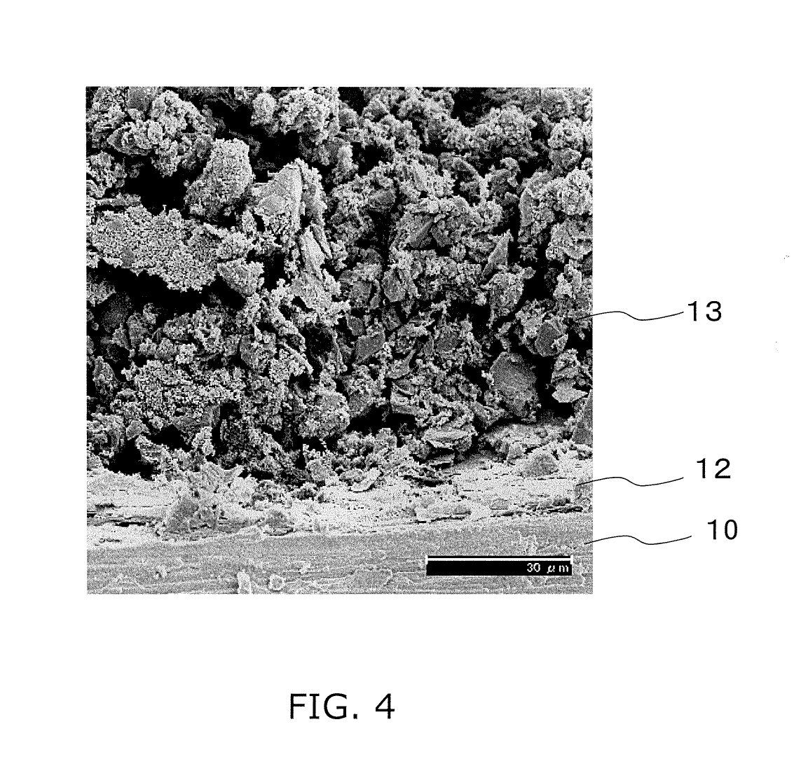

As described above, 20 μm of Varniphite™ (product No.: T602) was applied to the etched aluminum, this coated film was dried at 100° C. for 20 minutes to form the conductive coating film 12 on the collector 10, the conductive coating was further applied onto the conductive coating film 12 and dried to form the polarizable electrode 13, then frozen by liquid nitrogen, and the cross-section cut by a razor was evaluated by SEM photography. The SEM photograph is shown in FIG. 4. The film thickness of the conductive coating film 12 after the final formation of the polarized film 13 was confirmed to be approximately 5-10 μm.

### <Measurement of High Voltage Electric Discharge Property>

First, electronic power was connected to each laminated cell, and the charging voltage was increased to the specified voltage while constant current charging each laminated cell. Constant voltage state was maintained for about 5 minutes after the charging voltage reached the specified voltage, and after confirming that the charging current had sufficiently declined and had become a saturated state, subjected to constant current electric discharge, and cell voltage was measured every 0.5 seconds.

Then, the amount of electric discharge energy Ed (J) for every 0.5 seconds from the beginning to the end of electric discharge (until the cell voltage has declined to 0.6 V) was determined according to the below formula for calculating the amount of electric discharge energy from the measured cell voltage, and finally these amounts of electric discharge energy were integrated to calculate the total amount of electric discharge energy.

Ed=½×I×t×V

In the above formula, I is the constant current value (A), t is 0.5 seconds, and V is cell voltage (V).

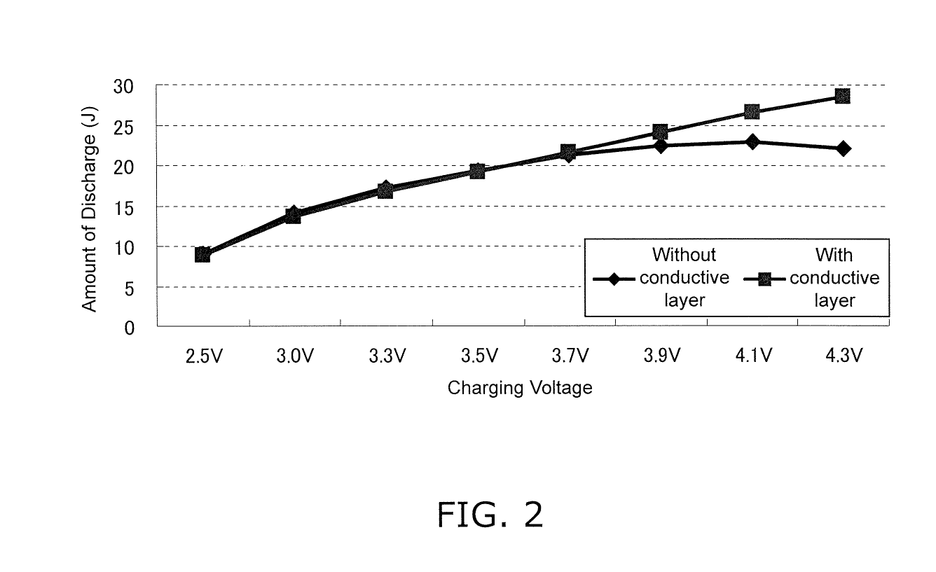

The total amount of electric discharge energy was also determined for each of the four laminated cells, and the average value of these was determined to be the final total amount of electric discharge energy. The results are shown in Table 1 and FIG. 2.

In this measurement, the constant current value in charging and discharging was targeted at 10 mA/F. The actual constant current value was 35 mA. Further in this Example, the current value was determined by connecting an 1Ω fixed resistance to the laminated cell in series, measuring the voltage between the two ends of this fixed resistance, and then calculating the value from the fixed resistance value (1Ω) and the measured voltage. The specified voltage in this Example was set at 2.5 V, 3.0 V, 3.3 V, 3.5 V, 3.7 V, 3.9 V, 4.1 V, and 4.3 V, and the above measurement was carried out at each specified voltage. At this time, the four constant current charge and discharge devices and a multichannel logger were employed to simultaneously measure the high voltage electric discharge property of the four laminated cells.

### Example 2

### Preparation of Rolled-Up Cell

The thin plate electrode prepared in Example 1 was cut into 34 mm widths, and then the thin plate electrodes were rolled together with Celgard No. 2400 from Celgard, LLC. by using EDLC winder from Kaido MFG. Co., Ltd. Subsequently, an electrode lead-out tab lead was connected by caulking to the thin plate electrodes to prepare a cylindrical rolled structure of 16 mm in diameter. After inserting this cylindrical rolled structure into a cylindrical aluminum case of 18 mm diameter×40 mm, the same electrolyte solution as in Example 1 was injected into the cylindrical aluminum case in a dry chamber, and the cylindrical aluminum case was sealed via a rubber packing to complete the rolled-up cell.

Two rolled-up cells were prepared as above in this Example.

### <Measurement of High Voltage Electric Discharge Property>

First, electronic power was connected to each rolled-up cell, and the charging voltage was increased to the specified voltage while constant current charging each rolled-up cell. Constant voltage state was maintained for about 5 minutes after the charging voltage reached the specified voltage, and after confirming that the charging current had sufficiently declined and had become a saturated state, subjected to constant current electric discharge, and cell voltage was measured every 0.5 seconds.

Then, the amount of electric discharge energy Ed (J) for every 0.5 seconds from the beginning to the end of electric discharge (until the cell voltage has declined to 0.6 V) was determined according to the below formula for calculating the amount of electric discharge energy from the measured cell voltage, and finally these amounts of electric discharge energy were integrated to calculate the total amount of electric discharge energy.

Ed=½×I×t×V

In the above formula, I is the constant current value (A), t is 0.5 seconds, and V is cell voltage (V).

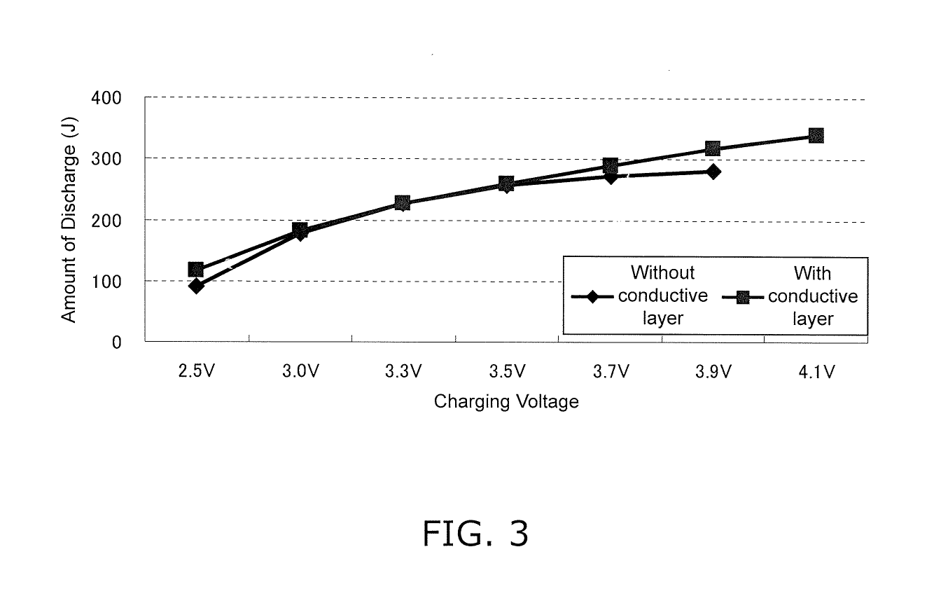

The total amount of electric discharge energy was also determined for each of the two rolled-up cells, and the average value of these was determined to be the final total amount of electric discharge energy. The results are shown in Table 2 and FIG. 3.

In this measurement, the constant current value in charging and discharging was targeted at 10 mA/F. Since the actual capacity of the prepared rolled-up cell was about 50 F, the actual constant current value was determined to be 500 mA. Further in this Example, the current value was determined by connecting a 0.1Ω fixed resistance to the rolled-up cell in series, measuring the voltage between the two ends of this fixed resistance, and then calculating the value from the fixed resistance value (0.1Ω) and the measured voltage. The specified voltage in this Example was set at 2.5 V, 3.0 V, 3.3 V, 3.5 V, 3.7 V, 3.9 V, and 4.1 V, and the above measurement was carried out at each specified voltage. At this time, the two constant current charge and discharge devices and a multichannel logger were employed to simultaneously measure the high voltage electric discharge property of the two rolled-up cells.

### Comparative Example 1

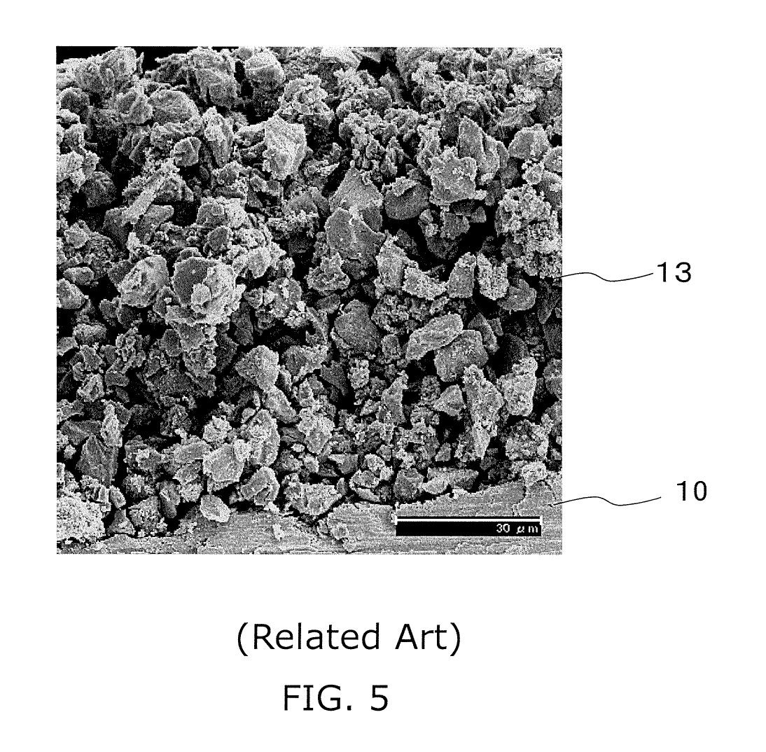

Similarly to Example 1 except the polarizable electrode was formed without forming a conductive coating film on the collector, four laminated cells were prepared. FIG. 5 shows the SEM photograph of the cross-section of a polarizable electrode formed without forming a conductive coating film on the collector, frozen by liquid nitrogen, and cut with a razor.

The total amount of electric discharge energy of the four laminated cells was also determined similarly to Example 1.

In this Comparative Example, the actual constant current value was 40 mA. The results are shown in Table 1 and FIG. 2.

### Comparative Example 2

Similarly to Example 2 except using a thin plate electrode wherein a polarizable electrode is formed without forming a conductive coating film on the collector, four rolled-up cells were prepared. The total amount of electric discharge energy of the four rolled-up cells was also determined similarly to Example 2.

In this Comparative Example, since the actual capacity of the prepared rolled-up cell was about 50 F, the actual constant current value was determined to be 500 mA. The results are shown in Table 2 and FIG. 3.

TABLE 1

| | Total Amount of Electric Discharge Energy (J) | | | | | | | | | |
|---|---|---|---|---|---|---|---|---|---|---|
| Specified | Example 1 | | | | | Comparative Example 1 | | | | |
| Voltage | No. 1 | No. 2 | No. 3 | No. 4 | Average | No. 1 | No. 2 | No. 3 | No. 4 | Average |
| 2.5 V | 8.68 | 8.53 | 9.22 | 8.82 | 8.81 | 8.92 | 8.78 | 9.09 | 8.99 | 8.94 |
| 3.0 V | 13.39 | 13.15 | 14.17 | 13.60 | 13.58 | 13.95 | 13.77 | 14.39 | 14.20 | 14.07 |
| 3.3 V | 16.41 | 16.23 | 17.57 | 16.72 | 16.73 | 16.92 | 16.92 | 17.71 | 17.53 | 17.27 |
| 3.5 V | 18.74 | 18.53 | 20.06 | 19.06 | 19.10 | 18.77 | 18.91 | 20.10 | 19.80 | 19.39 |
| 3.7 V | 21.37 | 21.10 | 22.73 | 21.67 | 21.72 | 20.42 | 20.67 | 22.35 | 21.71 | 21.29 |
| 3.9 V | 23.91 | 23.48 | 25.17 | 24.15 | 24.18 | 21.27 | 21.64 | 24.13 | 22.87 | 22.48 |
| 4.1 V | 26.39 | 25.78 | 27.36 | 26.59 | 26.53 | 21.34 | 21.59 | 25.45 | 23.27 | 22.91 |
| 4.3 V | 28.42 | 27.79 | 29.13 | 28.68 | 28.50 | 20.01 | 19.83 | 26.00 | 22.76 | 22.15 |

TABLE 2

| | Total Amount of Electric Discharge Energy (J) | | | | | | | |
|---|---|---|---|---|---|---|---|---|
| Specified | Example 2 | | | Comparative Example 2 | | | | |
| Voltage | No. 1 | No. 2 | Average | No. 1 | No. 2 | No. 3 | No. 4 | Average |
| 2.5 V | 116 | 117 | 116 | 92 | 91 | 91 | 92 | 91 |
| 3.0 V | 180 | 184 | 182 | 177 | 176 | 176 | 177 | 177 |
| 3.3 V | 224 | 230 | 227 | 227 | 227 | 227 | 227 | 227 |
| 3.5 V | 255 | 262 | 259 | 258 | 258 | 258 | 258 | 258 |
| 3.7 V | 287 | 294 | 290 | 273 | 272 | 276 | 272 | 273 |
| 3.9 V | 315 | 321 | 318 | 282 | 280 | 284 | 280 | 282 |
| 4.1 V | 334 | 343 | 339 | | | | | |

As apparent from Table 1 and FIG. 2, the laminated cell according to Example 1 is found to exert significant effect at a specified voltage of 3.9 V-4.3 V.

Also as apparent from Table 2 and FIG. 3, the rolled-up cell according to Example 2 is found to exert significant effect at specified voltages of 3.7 V and 3.9 V.

### INDUSTRIAL APPLICABILITY

The electric double layer capacitor according to the present invention is characterized in that it has a small voltage decrease during discharge when high voltage is applied and can carry out an electric discharge close to the electric discharge matching the charging voltage, and is thus effective for increase in capacitance.

### REFERENCE SIGNS LIST

1 Electric double layer capacitor
10 Collector
11 Separator
12 Conductive coating film
13 Polarizable electrode
14 Electrolyte solution

### CITATION LIST

### Patent Literature

<Patent Literature 1> Japanese Published Unexamined Patent Application Publication No. 2008-016560
<Patent Literature 2> Japanese Published Unexamined Patent Application Publication No. 2000-156328

### Non Patent Literature

<Non-patent Literature 1> Izaya Nagata, “Aluminum Electrolyte Capacitor with Liquid Electrolyte Cathode,” Japan Capacitor Industrial CO., LTD, Feb. 24, 1997

1. An electric double layer capacitor comprising:
a pair of collectors;
a separator arranged between the collectors;
a conductive coating film covering a surface of at least one of the collectors facing the separator;
a polarizable electrode formed so as to be in contact with at least a surface of the conductive coating film facing the separator; and
an electrolyte solution having a fluorine-containing organic solvent, the electrolyte solution being impregnated into the polarizable electrode.

2. An electric double layer capacitor which enables an operating voltage of 3.5 V or higher, the capacitor comprising:
a pair of collectors;
a separator arranged between the collectors;
a conductive coating film covering a surface of at least one of the collectors facing the separator;
a polarizable electrode formed so as to be in contact with at least a surface of the conductive coating film facing the separator;
an electrolyte solution.

3. The electric double layer capacitor according to claim 1, wherein
the electrolyte solution has a reaction current 0.1 mA/F or less in a stable state when a voltage of 3.3 V is applied thereto at 70° C.

4. The electric double layer capacitor according to claim 1, wherein
the conductive coating film is formed of graphite.

5. The electric double layer capacitor according to claim 1, wherein
the collector is aluminum.

6. The electric double layer capacitor according to claim 3, wherein the conductive coating film is formed of graphite.

7. The electric double layer capacitor according to claim 2, wherein
the electrolyte solution has a reaction current 0.1 mA/F or less in a stable state when a voltage of 3.3 V is applied thereto at 70° C.

8. The electric double layer capacitor according to claim 7, wherein the conductive coating film is formed of graphite.

9. The electric double layer capacitor according to claim 8, wherein the collector is aluminum.

10. The electric double layer capacitor according to claim 2, wherein the conductive coating film is formed of graphite.

11. The electric double layer capacitor according to claim 1, wherein the thickness of the conductive coating film is 10 μm or more.

12. The electric double layer capacitor according to claim 11, wherein the thickness of the conductive coating film is 100 μm or less.

13. The electric double layer capacitor according to claim 2, wherein the thickness of the conductive coating film is 10 μm or more.

14. The electric double layer capacitor according to claim 13, wherein the thickness of the conductive coating film is 100 μm or less.

15. The electric double layer capacitor according to claim 3, wherein
the thickness of the conductive coating film is in the range of 10 μm or more to 100 μm or less.

16. The electric double layer capacitor according to claim 7, wherein
the thickness of the conductive coating film is in the range of 10 μm or more to 100 μm or less.

17. The electric double layer capacitor according to claim 2, wherein
the solvent of the electrolyte solution is a fluorine-containing organic solvent, and
the electrolyte solution is impregnated into the polarizable electrode.

18. The electric double layer capacitor according to claim 17, wherein
the thickness of the conductive coating film is in the range of 60 μm or more to 100 μm or less.

19. The electric double layer capacitor according to claim 18, wherein the thickness of the conductive coating film is 10 μm or more.

20. The electric double layer capacitor according to claim 4, wherein the graphitization degree of the graphite is 0.6 or more to 0.8 or less.
